(19) United States
(12) Patent Application Publication
(10) Pub. No.: US 2009/0031391 A1
(43) Pub. Date: Jan. 29, 2009

(54) ELECTRONICALLY CONTROLLED CATV SYSTEM

(75) Inventor: Tibor Urbanek, Saline, MI (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: EMERSON NETWORK POWER CONNECTIVITY SOLUTIONS, Bannockburn, IL (US)

(21) Appl. No.: 12/045,645

(22) Filed: Mar. 10, 2008

Related U.S. Application Data
(60) Provisional application No. 60/893,814, filed on Mar. 8, 2007.

(51) Int. Cl. H04N 7/10

(52) U.S. Cl. 725/149

(57) ABSTRACT

A cable television system having combiners, splitters, amplifiers, directional couplers or other devices wherein the entire system is controlled electronically.

### CROSS-REFERENCE TO RELATED APPLICATIONS

This application claims priority of U.S. Provisional Patent Application No. 60/893,814, filed Mar. 8, 2007, in the United States Patent and Trademark Office, the disclosure of which is incorporated herein by reference in its entirety.

### BACKGROUND OF THE INVENTION

1. Field of the Invention

The present general inventive concept relates generally to electrical controls used, for example, with a cable television (CATV) system having combiners, splitters, equalizers, attenuators and the like.

2. Description of the Related Art

In CATV systems, devices called combiners and splitters are used to combine and split radio frequency (RF) signals. This type of system is commonly used at the central office of a cable TV system called a head-end office. All channels are first combined together until all channels are simultaneously present on the same coaxial line. This coaxial line is then split using splitters several ways so it can be fed to customers using either fiber optic or coax lines. A simplified architecture of this type of network is illustrated in FIG. 1.

Individual CATV channels, analog and digital, are combined using combiners. Typical combiners may have an adjustable or pluggable attenuator (ATT) on the input in order to be able to adjust the level of the signal to a proper level, and may look similar to one shown in FIG. 2. Some combiners may also have an attenuator added to the output port, and that attenuator is either adjustable or pluggable. In some cases, adjustable or pluggable equalizers (EQ) may be installed on the input port. Often, a directional coupler is on the input port in order to have an easily accessible test point for measuring signal levels. Similarly, when signals are being split, a splitter is being used, as illustrated in FIG. 2.

A combiner device and a splitter device are essentially the same devices with very minor differences, mainly in test port direction configuration and perhaps port marking. For the purpose of the present general inventive concept, the terms combiner and splitter may be used interchangeably.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims. A more complete appreciation of the invention and many of the advantages thereof will be readily obtained as the same becomes better understood by references to the detailed description when considered in connection with the accompanying drawings, wherein:

FIG. 1 is a schematic of a conventional network of prior art showing the simplified architecture of a known network system used in a cable TV system.

FIG. 2a is a schematic of prior art showing an example of a conventional combiner network.

FIG. 2b is a schematic of prior art showing an example of a conventional splitter network.

FIG. 3 is a schematic of a system illustrating an exemplary embodiment of the present system that is electronically controlled.

FIG. 4 is a schematic of an electronically controlled system of the present general inventive concept showing the use of several combiner/splitters, a control microprocessor controller, and a personal computer monitoring the system.

FIG. 5 is a schematic of system illustrating another exemplary embodiment of the present system that is electronically controlled.

### SUMMARY OF THE INVENTION

A principal object of the present general inventive concept is to provide an electronically controlled CATV system. Another object of the invention is to provide a system that includes a splitter and/or combiner and an amplifier where the entire system is electronically controlled, including remotely.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### DESCRIPTION OF THE PREFERRED EMBODIMENTS

As required, one or more detailed embodiments of the present general inventive concept are disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present general inventive concept in virtually any appropriately detailed structure.

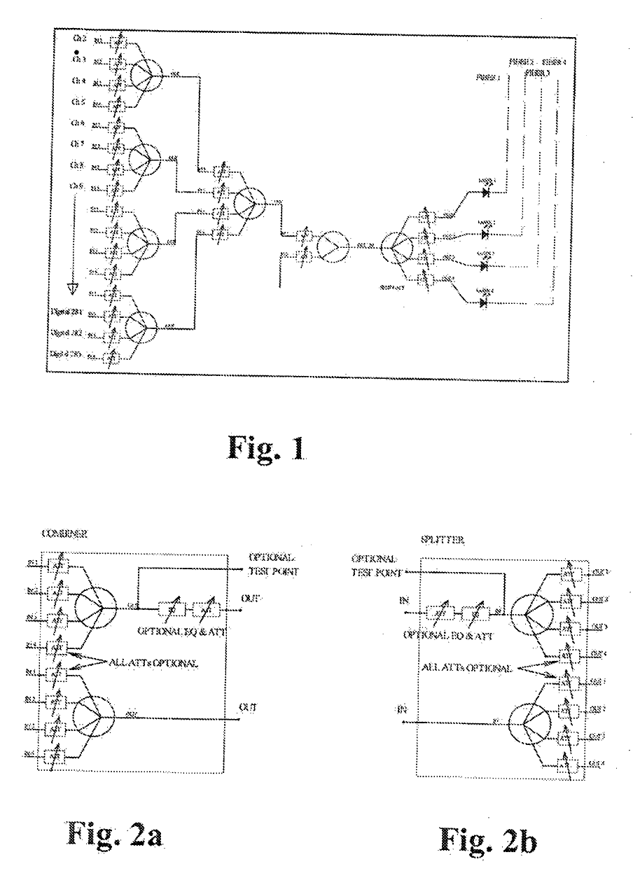

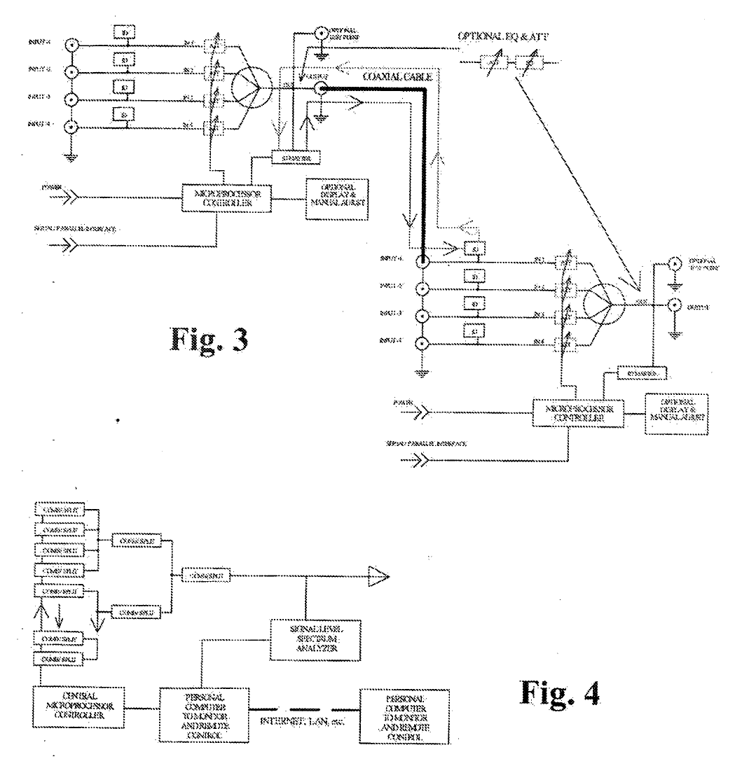

Referring to FIG. 3, in one embodiment, an electronically controlled attenuator is used in a CATV or similar system, instead of an adjustable or pluggable attenuator ATT as was described above in prior systems as shown in FIGS. 1 and 2. In one embodiment, all adjustable or pluggable attenuators ATT are replaced with electronically controlled attenuators. The electronic attenuator is controlled using analog voltage levels. In another embodiment, the electronic attenuator is controlled digitally with parallel or serial signals. The entire combiner or splitter may be controlled with a built in microprocessor or other controlling device. In one embodiment the entire combiner or splitter is controlled by a series of manual switches. Electronically controlled attenuators are added to an output port in case of combiners or an input port in case of splitters.

In one embodiment, referring to FIG. 3, an electronically adjustable equalizer EQ is added an input or an output port or multiple equalizers EQ are added to multiple ports. Each input port in case of combiners or output port in case of splitters contains an electronic ID (e.g., a 64 bit code), and each output port in case of combiners or input port in case of splitters contains an ID master reader connected to a microprocessor of each individual combiner or splitter. The ID master reader and the electronic ID communicate with each other using already connected coaxial line (used for carrying radio frequency (RF) signals already) and the ID master reader tells the microprocessor the exact kind and serial number of a combiner/splitter connected to its output/input (e.g., the ID master reader generates an output signal to send to the microprocessor). This information is later transmitted by combiner/splitter's microprocessor to a central microprocessor, and later to a personal computer, for example.

FIG. 4 illustrates an embodiment where microprocessor controllers are used in combiners/splitters, the entire combining/splitting network may be connected to a central microprocessor which can, for example, be connected to a personal computer. Using appropriate software or other technology known, each attenuator or equalizer of each individual port of each combiner/splitter can be remotely controlled using any of the available computing devices, such as, for example, a personal computer, PDA, handheld communicator, etc. This is done directly at the head-end office of the CATV system. In another embodiment it is done from a remote location using internet or any other available networking systems.

Referring to FIG. 4, in an embodiment where electronic IDs and ID master readers are used, appropriate software in a personal computer can automatically draw a schematic of the entire combining/splitting system. Using appropriate software, electronic IDs and ID master readers determine if all the connections using a coaxial radio frequency (RF) cable are uninterrupted, since RF signals travel through the same line as electronic ID and ID masters. For example, a network or multiple networks with modules can electrically communicate with one another through microprocessor to control and monitor the signals sent through the system.

Referring to FIG. 4, where appropriate interface, signal or spectrum analyzer, and software are used, a personal computer can automatically adjust the level of each individual attenuator or equalizer of each individual port of each combiner/splitter to a level specified by a user. This is done directly at the head-end office of the cable TV system. In another embodiment it is done from a remote location using internet or any other available networking systems. The electronically controlled system enables a fully automated remote monitoring and trouble shooting process of the entire splitting/combining network. The electronically controlled system sends a message, such as, for example, an e-mail, text message, facsimile or voicemail in cases where a malfunction of the electronically controlled system is detected.

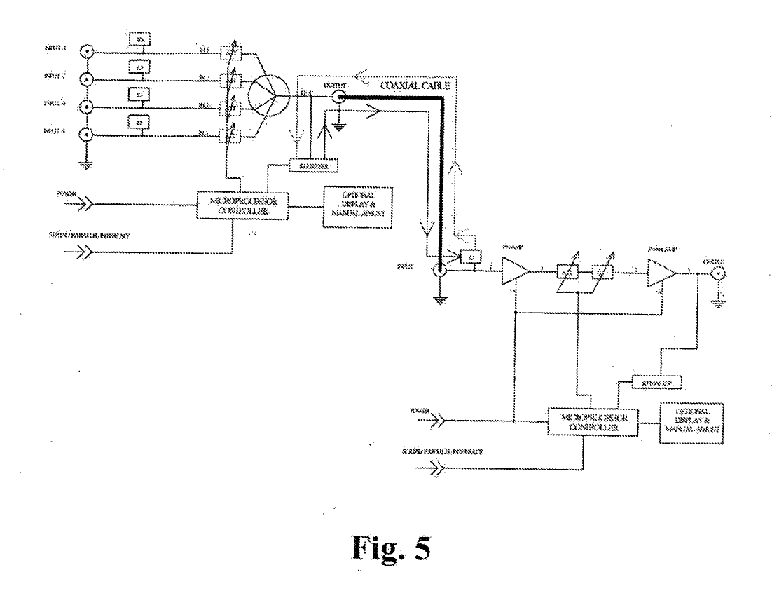

The usage of electronically controlled attenuators or equalizers is not limited to splitters and combiners, but is used, for example, in directional couplers, diplex filter, amplifiers and other similar devices. Similarly, the electronic ID and the ID master readers and microprocessor controllers are used in these devices. Referring to FIG. 5, an amplifier configuration is shown using the mentioned devices working in cooperation with an output combiner.

Although the foregoing detailed description of the present general inventive concept has been described by reference to an exemplary embodiment, and the best mode contemplated for carrying out the present general inventive concept has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present general inventive concept. Therefore, it is contemplated to cover the present general inventive concept and any and all changes, modifications, variations, or equivalents that fall with in the true spirit and scope of the underlying principles disclosed and claimed herein. Consequently, the scope of the present general inventive concept is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims. It is also to be understood that the following claims are intended to cover all of the generic and specific features of the invention herein described, and all statements of the scope of the invention which, as a matter of language, might be said to fall there between.

What is claimed is:

1. A CATV system, comprising:
combiners, splitters, amplifiers, directional couplers or other devices wherein the entire system is controlled electronically.
